(19) United States
(12) Patent Application Publication
(10) Pub. No.: US 2014/0247102 A1
(43) Pub. Date: Sep. 4, 2014

(54) MULTILAYER COIL AND A MANUFACTURING METHOD THEREOF

(71) Applicant: MURATA MANUFACTURING CO., LTD., Kyoto (JP)

(72) Inventor: Junji KUROBE, Nagaokakyo-shi (JP)

(73) Assignee: MURATA MANUFACTURING CO., LTD., Kyoto (JP)

(21) Appl. No.: 14/171,274

(22) Filed: Feb. 3, 2014

(30) Foreign Application Priority Data
Mar. 1, 2013 (JP) 2013-040467

(51) Int. Cl. H01F 5/06; H01F 41/04; H01F 5/00

(52) U.S. Cl. CPC H01F 5/06; H01F 5/003; H01F 41/041
USPC 336/200; 427/58

(57) ABSTRACT

A multilayer coil having a laminate body having a plurality of insulating layers including a specified insulating layer. A linear coil conductor is substantially looped on the specified insulating layer. An insertion is located on the specified insulating layer, in a position between a first part and a second part of the coil conductor. The first part and the second part are closest parts to each other in the coil conductor. Along a boundary surface between the first part of the coil conductor and the insertion, the first part is located at an upper side of the coil conductor with respect to a stacking direction.

### CROSS REFERENCE

This application claims benefit of priority to Japanese Patent Application No. 2013-040467 filed on Mar. 1, 2013, the entire content of which is incorporated herein by reference.

### TECHNICAL FIELD

The present disclosure relates to a multilayer coil and a manufacturing method thereof.

### BACKGROUND

As a conventional laminated coil, for example, a multilayer electronic component 500 disclosed by Japanese Patent Laid-Open Publication No. 2001-176725 is known. FIG. 28 is a perspective view of the multilayer electronic component 500 disclosed by Japanese Patent Laid-Open Publication No. 2001-176725. FIG. 29 is a plan view of a ceramic green sheet 501h and a conductor 502g for a coil of the multilayer electronic component 500 disclosed by Japanese Patent Laid-Open Publication No. 2001-176725. In the following paragraphs, a direction in which ceramic green sheets are stacked is referred to as a z-axis direction. A surface at a positive z-axis side is referred to as an upper surface, and a surface at a negative z-axis side is referred to as a lower surface. A lengthwise direction and a widthwise direction of the ceramic green sheets are referred to as an x-axis direction and a y-axis direction, respectively. The x-axis direction, the y-axis direction and the z-axis direction are perpendicular to each other.

The multilayer electronic component 500 comprises ceramic green sheets 501a to 501j, conductors 502a to 502h for a coil (which will be hereinafter referred to as coil conductors 502a to 502h), via-hole conductors 503a to 503g, and terminal electrodes (not shown). The ceramic green sheets 501a to 501j are rectangular insulating layers, when viewed from the z-axis direction. The coil conductors 502a to 502g are linear conductors, each forming a rectangular loop with a missing part. The coil conductor 502h is a conductive layer located on the upper surface of the ceramic green sheet 501i.

In the multilayer electronic component 500, the ceramic green sheets 501a to 501i and the coil conductors 502a to 502h are stacked alternately by disposing the coil conductor 502h on the upper surface of the ceramic green sheet 501i, disposing the ceramic green sheet 501h on the upper surface of the ceramic green sheet 501i and the like. However, the ceramic green sheet 501i is placed on the upper surface of the ceramic green sheet 501j. The coil conductors 502a and 502h are connected by via-hole conductors 503a to 503g. The coil conductors 502a and 502h are connected also to the terminal electrodes located on side surfaces of the multilayer electronic component 500.

In the multilayer electronic component 500, in order to prevent trouble from taking place due to a short-circuit caused by blurring and/or misplacement occurring at the time of printing of the coil conductor 502g, as shown by FIG. 29, the distance d500 between pad portions 504 and 505, which are the ends of the coil conductor 502g, is set to be large. The pad portion 505 is located separate from the pad portion 504, and specifically, located at a position farther in a negative x-axis direction and farther in a positive y-axis direction from the pad portion 504. With the increase in distance between the pad portions 504 and 505, however, the length of the coil conductor 502g is shortened. With regard to the coil conductors 502a to 502f also, since the distances between the respective pad portions are large, the lengths of the coil conductors 502a to 502f are short. In the multilayer electronic component 500, therefore, the coil formed of the coil conductors 502a to 502g has a small number of turns, and it is difficult to obtain desired characteristics as a coil.

### SUMMARY

The present disclosure provides a multilayer coil that can prevent a short circuit caused by blurring and/or misplacement occurring at the time of printing of conductors for a coil without reducing the number of turns of the coil.

A multilayer coil according to an embodiment comprises: a laminate body formed by stacking a plurality of insulating layers including a specified insulating layer; a linear coil conductor substantially looped on the specified insulating layer; and an insertion located on the specified insulating layer, in a position between a first part and a second part of the coil conductor, the first part and the second part being closest parts to each other in the coil conductor. In the multilayer coil, along a boundary surface between the first part of the coil conductor and the insertion, the first part is located at an upper side of the coil conductor with respect to a stacking direction.

A method for manufacturing a multilayer coil according to an embodiment is a method for manufacturing a multilayer coil comprising: a laminate body formed by stacking a plurality of insulating layers including a specified insulating layer; a linear coil conductor substantially looped on the specified insulating layer; and an insertion located on the specified insulating layer, in a position between a first part and a second part of the coil conductor, the first part and the second part being closest parts to each other in the coil conductor. The method comprises: a step of forming the specified insulating layer; a step of forming the insertion on the specified insulating layer; and a step of forming the coil conductor on the specified insulating layer after the step of forming the insertion.

### BRIEF DESCRIPTION OF THE DRAWINGS

FIG. 1 is a perspective view of a multilayer coil according to an embodiment.

FIG. 2 is an exploded view of a laminate body of the multilayer coil according to the embodiment.

FIG. 3 is a plan view of an insulating layer, a coil conductor and an insertion of the multilayer coil according to the embodiment, when viewed from a layer-stacking direction.

FIG. 4 is a sectional view take along the line A-A shown in FIG. 3.

FIG. 5 is a plan view of an insulating layer, a coil conductor and an insertion of the multilayer coil according to the embodiment, when viewed from the layer-stacking direction.

FIG. 6 is a sectional view take along the line B-B shown in FIG. 5.

FIG. 7 is a plan view of an insulating layer, a coil conductor and an insertion of the multilayer coil according to the embodiment, when viewed from the layer-stacking direction.

FIG. 8 is a sectional view take along the line C-C shown in FIG. 3.

FIG. 9 is a plan view of the multilayer coil according to the embodiment during a manufacturing process thereof, when viewed from the layer-stacking direction.

FIG. 10 is a sectional view take along the line D-D shown in FIG. 9.

FIG. 11 is a plan view of the multilayer coil according to the embodiment during a manufacturing process thereof, when viewed from the layer-stacking direction.

FIG. 12 is a sectional view taken along the line E-E shown in FIG. 11.

FIG. 13 is a plan view of the multilayer coil according to the embodiment during a manufacturing process thereof, when viewed from the layer-stacking direction.

FIG. 14 is a sectional view taken along the line F-F shown in FIG. 13.

FIG. 15 is a plan view of the multilayer coil according to the embodiment during the manufacturing process thereof, when viewed from the layer-stacking direction.

FIG. 16 is a sectional view taken along the line G-G shown in FIG. 15.

FIG. 17 is a plan view of the multilayer coil according to the embodiment during the manufacturing process thereof, when viewed from the layer-stacking direction.

FIG. 18 is a sectional view taken along the line H-H shown in FIG. 17.

FIG. 19 is a plan view of the multilayer coil according to the embodiment during the manufacturing process thereof, when viewed from the layer-stacking direction.

FIG. 20 is a sectional view taken along the line I-I shown in FIG. 19.

FIG. 21 is a plan view of the multilayer coil according to the embodiment during the manufacturing process thereof, when viewed from the layer-stacking direction.

FIG. 22 is a sectional view taken along the line J-J shown in FIG. 21.

FIG. 23 is a plan view of the multilayer coil according to the embodiment during the manufacturing process thereof, when viewed from the layer-stacking direction.

FIG. 24 is a sectional view taken along the line K-K shown in FIG. 23.

FIG. 25 is a plan view of a print pattern for a magnetic part (insulating layer) of a multilayer coil according to a modification, when viewed from the layer-stacking direction.

FIG. 26 shows a state where the magnetic part according to the print pattern has been printed.

FIG. 27 is a sectional view taken along the line L-L shown in FIG. 26.

FIG. 28 is a perspective view of a multilayer electronic component disclosed by Japanese Patent Laid-Open Publication No. 2001-176725.

FIG. 29 is a plan view of a ceramic green sheet and a coil conductor of the multilayer electronic component disclosed by Japanese Patent Laid-Open Publication No. 2001-176725.

### DETAILED DESCRIPTION

A multilayer coil according to an embodiment and a manufacture method thereof will be hereinafter described.

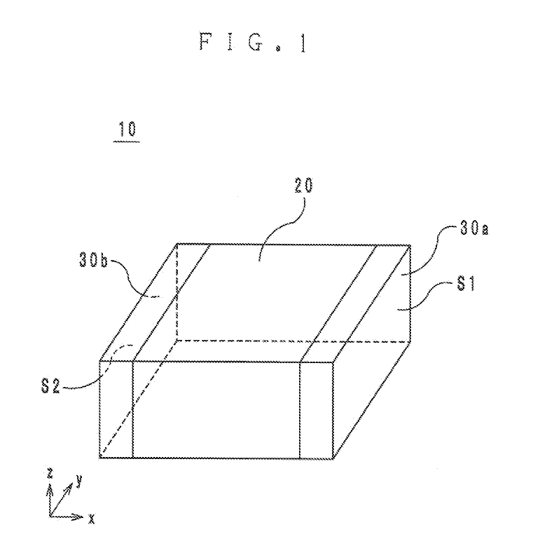

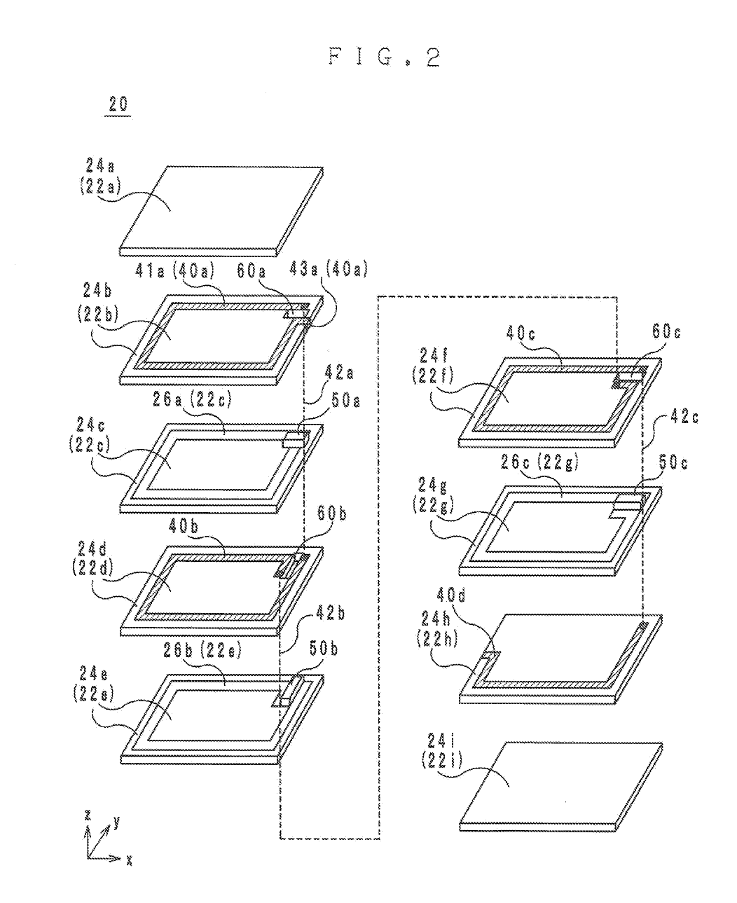

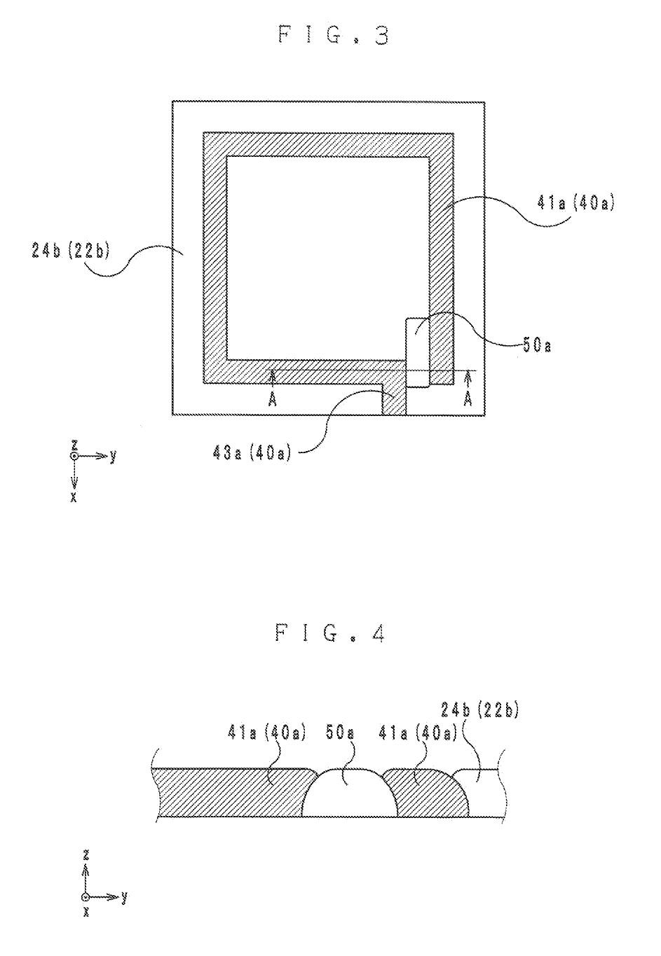

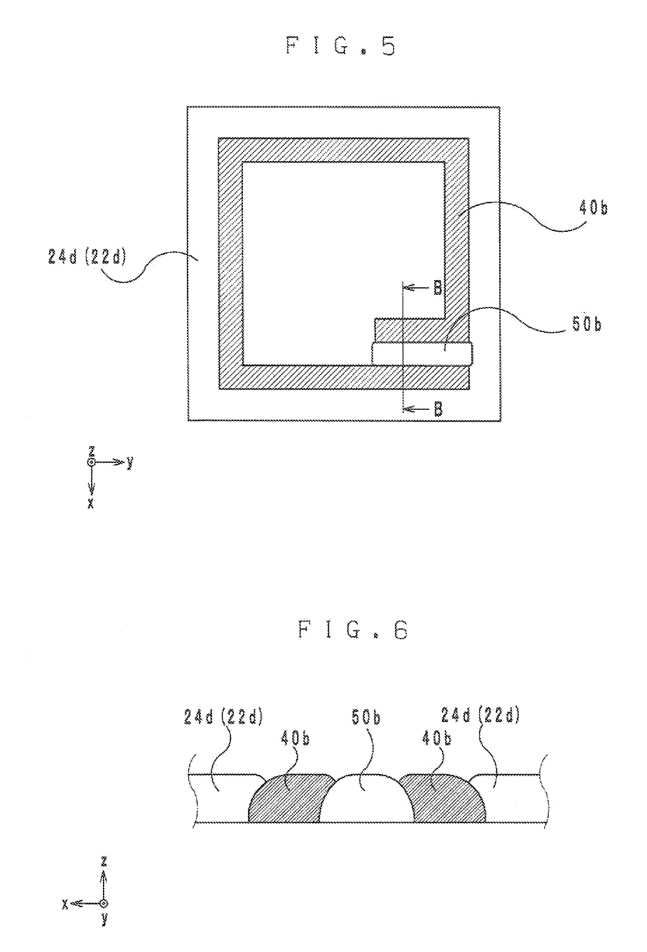

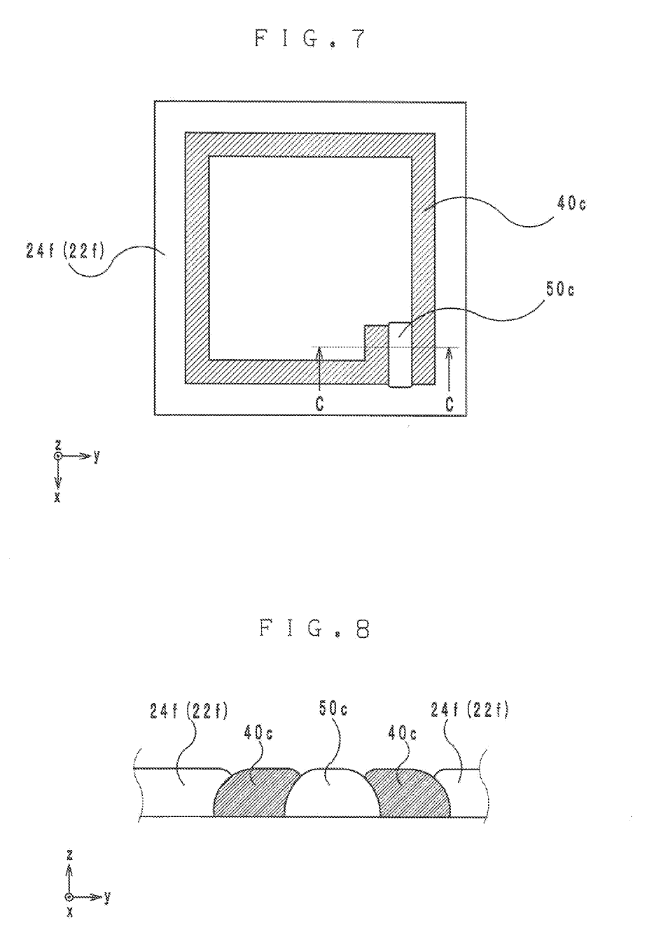

The structure of a multilayer coil 10 according to an embodiment is described with reference to the drawings. FIG. 1 is a perspective view of the multilayer coil 10. FIG. 2 is an exploded view of the multilayer coil 10. FIG. 3 is a plan view of an insulating layer 22b, a coil conductor 40a and an insertion 50a. FIG. 5 is a plan view of an insulating layer 22d, a coil conductor 40b and an insertion 50b. FIG. 7 is a plan view of an insulating layer 22f, a coil conductor 40c and an insertion 50c. FIG. 4 is a sectional view taken along the line A-A shown in FIG. 3. FIG. 6 is a sectional view taken along the line B-B shown in FIG. 5. FIG. 8 is a sectional view taken along the line C-C shown in FIG. 7. A direction in which the layers of the multilayer coil 10 are stacked is defined as a z-axis direction. Directions in which the sides of the multilayer coil 10 in a plane viewed from the z-axis direction extend are defined as an x-axis direction and a y-axis direction. The x-axis direction and the y-axis direction are perpendicular to each other.

### General Structure of the Multilayer Coil

The multilayer coil 10 comprises a laminate body 20, external electrodes 30a and 30b, coil conductors 40a to 40c, via-hole conductors 42a to 42c, and insertions 50a to 50c. The multilayer coil 10 is, as shown by FIG. 1, a rectangular parallelepiped.

### Structure of the Laminate Body

As shown by FIG. 2, the laminate body 20 is formed by stacking insulating layers 22a to 22i in this order from a positive z-axis side. Each of the insulating layers 22a to 22i is rectangular when viewed from the z-axis direction. Accordingly, the laminate body 20, which is formed by stacking the insulating layers 22a to 22i, is a rectangular parallelepiped as shown by FIG. 1. A surface of each of the insulating layers 22a to 22i at the positive z-axis side is referred to as an upper surface, and a surface of each of the insulating layers 22a to 22i at the negative z-axis side is referred to as a lower surface.

The insulating layer 22a is located at the positive z-axis end of the laminated body 20. The insulating layer 22a is a magnetic layer 24a. The magnetic layer 24a and the magnetic layers 24b to 24i which will be described later are made of a magnetic material, such as ferrite or the like.

The insulating layer 22b is, as shown in FIG. 2, located on the lower surface of the insulating layer 22a. The insulating layer 22b is a magnetic layer 24b. The insulating layer 22b has a rectangular through-hole 60a pierced therein in the z-axis direction, near a corner made by a positive x-axis side and a positive y-axis side of the insulating layer 22b, which are parts of the outer edge of the insulating layer 22b. A coil conductor 40a, which will be described later, is embedded in the insulating layer 22b.

The insulating layer 22c (a specified insulating layer) is, as shown in FIG. 2, located on the lower surface of the insulating layer 22b. The insulating layer 22c comprises a magnetic part 24c and a non-magnetic part 26a. The non-magnetic part 26a is a strip-shaped portion arranged along the outer edge of the insulating layer 22c so as to substantially form a rectangular loop, when viewed from the z-axis direction. The magnetic part 24c is located outside and inside the rectangular loop made by the non-magnetic part 26a, when viewed from the z-axis direction. The non-magnetic part 26a and the non-magnetic part 26b to 26c which will be described later are made of a non-magnetic material, for example, mainly composed of borosilicate glass and ceramic filler, or the like.

The insulating layer 22d is, as shown in FIG. 2, located on the lower surface of the insulating layer 22c. The insulating layer 22d is a non-magnetic layer 24d. The insulating layer 22d has a rectangular through-hole 60b pierced therein in the z-axis direction, near a corner made by a positive x-axis side and a positive y-axis side of the insulating layer 22d, which are parts of the outer edge of the insulating layer 22d. A coil conductor 40b, which will be described later, is embedded in the insulating layer 22d.

The insulating layer 22e (a specified insulating layer) is, as shown in FIG. 2, located on the lower surface of the insulating layer 22d. The insulating layer 22e comprises a magnetic part 24e and a non-magnetic part 26b. The non-magnetic part 26b is a strip-shaped portion arranged along the outer edge of the insulating layer 22e so as to substantially form a rectangular loop, when viewed from the z-axis direction. The magnetic part 24e is located outside and inside the rectangular loop made by the non-magnetic part 26b, when viewed from the z-axis direction.

The insulating layer 22f is, as shown in FIG. 2, located on the lower surface of the insulating layer 22e. The insulating layer 22f is a non-magnetic layer 24f. The insulating layer 22f has a rectangular through-hole 60c pierced therein in the z-axis direction, near a corner made by a positive x-axis side and a positive y-axis side of the insulating layer 22f, which are parts of the outer edge of the insulating layer 22f. A coil conductor 40c, which will be described later, is embedded in the insulating layer 22f.

The insulating layer 22g (a specified insulating layer) is, as shown in FIG. 2, located on the lower surface of the insulating layer 22f. The insulating layer 22g comprises a magnetic part 24g and a non-magnetic part 26c. The non-magnetic part 26c is a strip-shaped portion arranged along the outer edge of the insulating layer 22g so as to substantially form a rectangular loop, when viewed from the z-axis direction. The magnetic part 24g is located outside and inside the rectangular loop made by the non-magnetic part 26c, when viewed from the z-axis direction.

The insulating layer 22h is, as shown in FIG. 2, located on the lower surface of the insulating layer 22g. The insulating layer 22h is a magnetic layer 24h. A coil conductor 40d, which will be described later, is embedded in the insulating layer 22h.

The insulating layer 22i is, as shown in FIG. 2, located on the lower surface of the insulating layer 22h. The insulating layer 22i is located at the negative z-axis end of the laminate body 20. The insulating layer 22i is a magnetic layer 24i.

### Structure of the External Electrodes

As shown in FIG. 1, the external electrode 30a is disposed to cover a side surface S1 at a positive x-axis side of the laminate body 20. The external electrode 30b is disposed to cover a side surface S2 at a negative x-axis side of the laminate body 20. The external electrodes 30a and 30b are made of a conductive material, such as Ag, Pd, Cu, Ni or the like.

### Structure of the Coil Conductors

The coil conductor 40a is, as shown in FIG. 2, embedded in the insulating layer 22b, and has the same thickness as the insulating layer 22b. Accordingly, the coil conductor 40a is exposed on the lower surface of the insulating layer 22b and is located on the upper surface of the insulating layer 22c (specified insulating layer). The coil conductor 40a comprises a coil portion 41a and a lead portion 43a.

The coil portion 41a is a strip-shaped portion arranged along the outer edge of the insulating layer 22b so as to substantially form a rectangular loop, when viewed from the z-axis direction. That is, the coil portion 41a is substantially looped on the upper surface of the insulating layer 22c. Thus, the coil portion 41a has a length substantially corresponding to one turn of a helical coil. However, the coil portion 41a is split by the through-hole 60a. Accordingly, the coil portion 41a has both ends facing each other across the through-hole 60a, and the ends are the closest parts to each other in the coil portion 41a.

The lead portion 43a connects one end (first end) of the coil portion 41a to the external electrode 30a located on the side surface S1 of the laminate body 20. The other end (second end) of the coil portion 41a, that is, the other end of the coil conductor 40a is connected to the via-hole conductor 42a pierced in the insulating layer 22 in the z-axis direction. Thus, the coil conductor 40a connects the external electrode 30a to the via-hole conductor 42a while circling clockwise, when viewed from the positive z-axis side. The coil conductor 40a, the coil conductors 40b to 40d which will be described later, the via-hole conductor 42a, and the via-hole conductors 42b to 42c which will be described later are made of a conductive material, such as Ag, Pd, u, Ni or the like.

The coil conductor 40b is, as shown in FIG. 2, embedded in the insulating layer 22d, and has the same thickness as the insulating layer 22d. Accordingly, the coil conductor 40b is exposed on the lower surface of the insulating layer 22d and is located on the upper surface of the insulating layer 22e (specified insulating layer). The coil conductor 40b is a strip-shaped conductor arranged along the outer edge of the insulating layer 22d so as to substantially form a rectangular loop, when viewed from the z-axis direction. That is, the coil conductor 40b is substantially looped on the upper surface of the insulating layer 22e. Thus, the coil conductor 40b has a length substantially corresponding to one turn of a helical coil. However, the coil conductor 40b is split by the through-hole 60b. Accordingly, the coil conductor 40b has both ends facing each other across the through-hole 60b, and the ends are the closest parts to each other in the coil conductor 40b. One end (first end) of the coil conductor 40b is connected to the via-hole conductor 42a. Thereby, the coil conductor 40b is electrically connected to the coil conductor 40a. The coil conductors 40a and 40b are opposed to each other via the non-magnetic part 26a. The other end (second end) of the coil conductor 40b is connected to the via-hole conductor 42b pierced in the insulating layer 22e in the z-axis direction. Thus, the coil conductor 40b connects the via-hole conductor 42a to the via-hole conductor 42b while circling clockwise, when viewed from the positive z-axis side.

The coil conductor 40c is, as shown in FIG. 2, embedded in the insulating layer 22f, and has the same thickness as the insulating layer 22f. Accordingly, the coil conductor 40c is exposed on the lower surface of the insulating layer 22f and is located on the upper surface of the insulating layer 22g (specified insulating layer). The coil conductor 40c is a strip-shaped conductor arranged along the outer edge of the insulating layer 22f so as to substantially form a rectangular loop, when viewed from the z-axis direction. That is, the coil conductor 40c is substantially looped on the upper surface of the insulating layer 22g. Thus, the coil conductor 40c has a length substantially corresponding to one turn of a helical coil. However, the coil conductor 40c is split by the through-hole 60c. Accordingly, the coil conductor 40c has both ends facing each other across the through-hole 60c, and the ends are the closest parts to each other in the coil conductor 40c. One end (first end) of the coil conductor 40c is connected to the via-hole conductor 42b. Thereby, the coil conductor 40c is electrically connected to the coil conductor 40b. The coil conductors 40b and 40c are opposed to each other via the non-magnetic part 26b. The other end (second end) of the coil conductor 40c is connected to the via-hole conductor 42c pierced in the insulating layer 22g in the z-axis direction. Thus, the coil conductor 40c connects the via-hole conductor 42b to the via-hole conductor 42c while circling clockwise, when viewed from the positive z-axis side.

The coil conductor 40d is, as shown in FIG. 2, embedded in the insulating layer 22h, and has the same thickness as the insulating layer 22h. Accordingly, the coil conductor 40d is exposed on the lower surface of the insulating layer 22h and is located on the upper surface of the insulating layer 22i. The coil conductor 40d is a strip-shaped conductor arranged along the positive and negative x-axis sides and the negative y-axis side of the insulating layer 22h, which are parts of the outer edge of the insulating layer 22h. The part of the coil conductor 40d along the negative x-axis side is lead out from substantially the center in the y-axis direction to the side surface S2. Thereby, one end of the coil conductor 40d is connected to the external electrode 30b. The other end of the coil conductor 40d is connected to the via-hole conductor 40c. Thus, the coil conductor 40d is electrically connected to the coil conductor 40c. The coil conductors 40c and 40d are opposed to each other via the non-magnetic part 26c.

### Structure of the Insertions

The insertion 50a is, as shown in FIG. 2, disposed on the upper surface of the insulating layer 22c. The insertion 50a is located in the same position as the through-hole 60a, when viewed from the z-axis direction. Accordingly, when the insulating layers 22b and 22c are stacked together, as shown by FIGS. 3 and 4, the insertion 50a is located between the both ends (a first part and a second part) of the coil portion 41a. The insertion 50a, and the insertions 50b and 50c which will be described later are made of a non-magnetic material, for example, mainly composed of borosilicate glass and ceramic filler, or the like. The insertions 50a, 50b and 50c are preferably non-magnetic, but these insertions 50a, 50b and 50c may be magnetic.

The insertion 50b is, as shown in FIG. 2, disposed on the upper surface of the insulating layer 22e. The insertion 50b is located in the same position as the through-hole 60b, when viewed from the z-axis direction. Accordingly, when the insulating layers 22d and 22e are stacked together, as shown by FIGS. 5 and 6, the insertion 50b is located between the both ends (a first part and a second part) of the coil conductor 40b.

The insertion 50c is, as shown in FIG. 2, disposed on the upper surface of the insulating layer 22g. The insertion 50c is located in the same position as the through-hole 60c, when viewed from the z-axis direction. Accordingly, when the insulating layers 22f and 22g are stacked together, as shown by FIGS. 7 and 8, the insertion 50c is located between the both ends (a first part and a second part) of the coil conductor 40c.

### Manufacturing Method of the Multilayer Coil

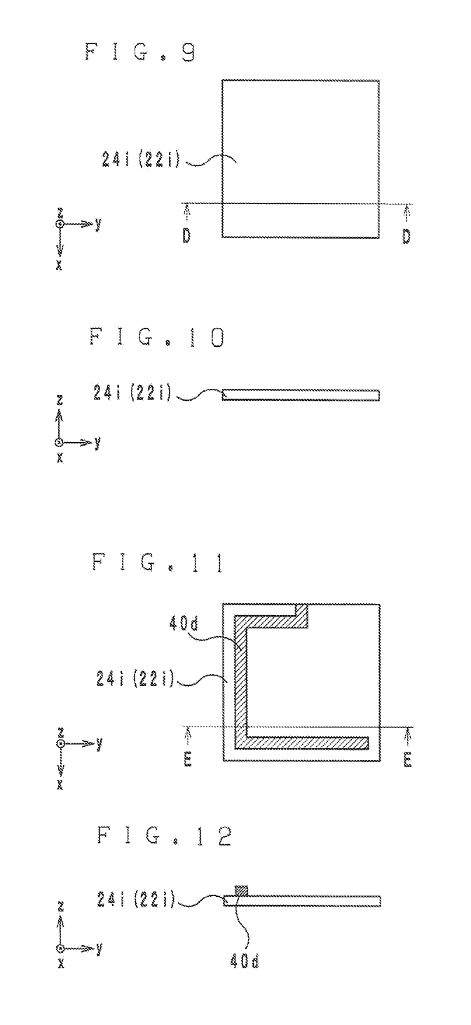

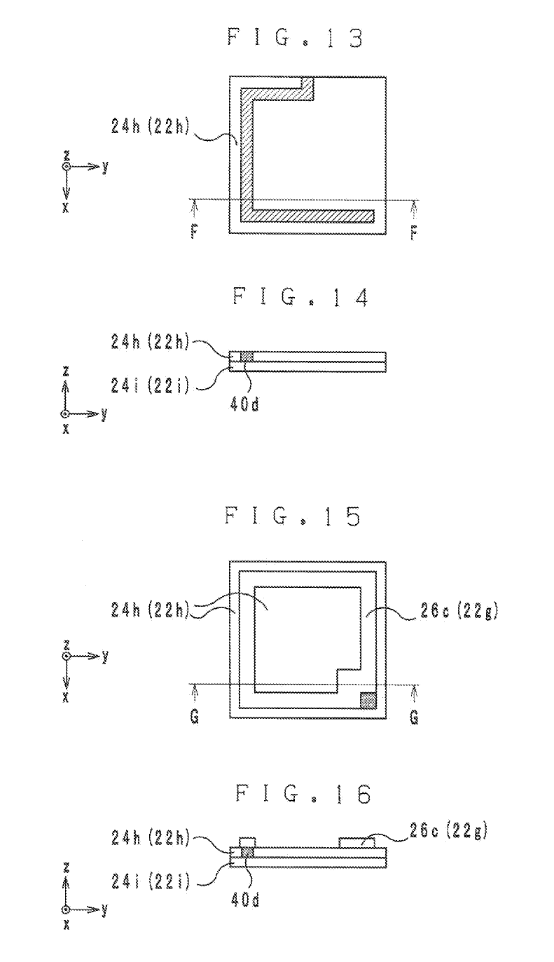

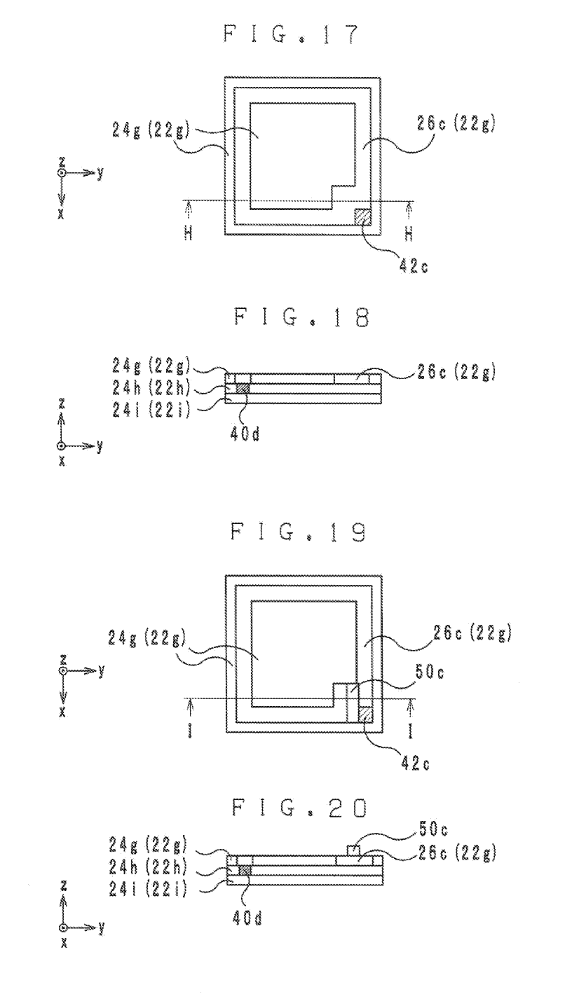

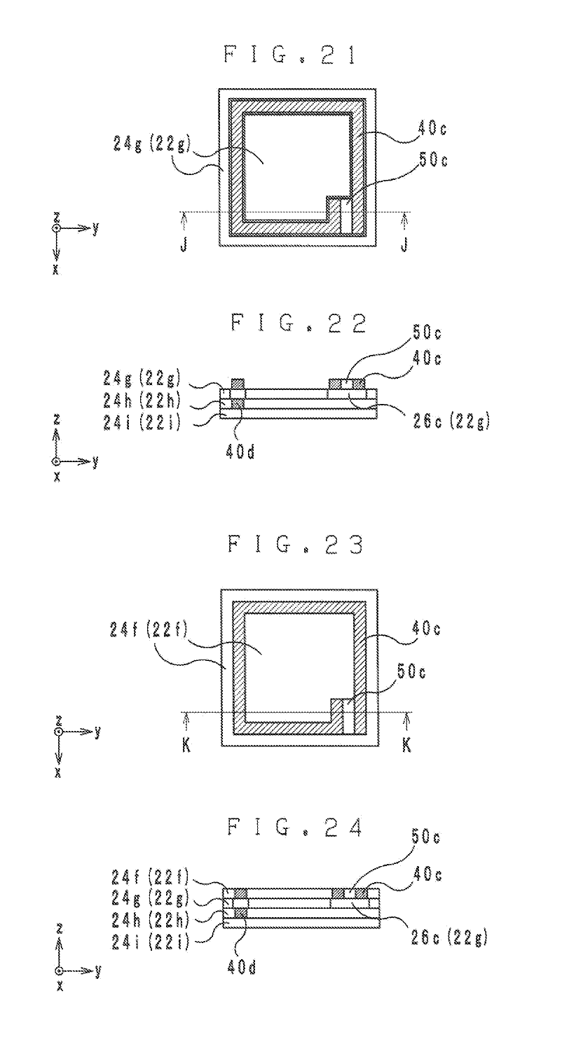

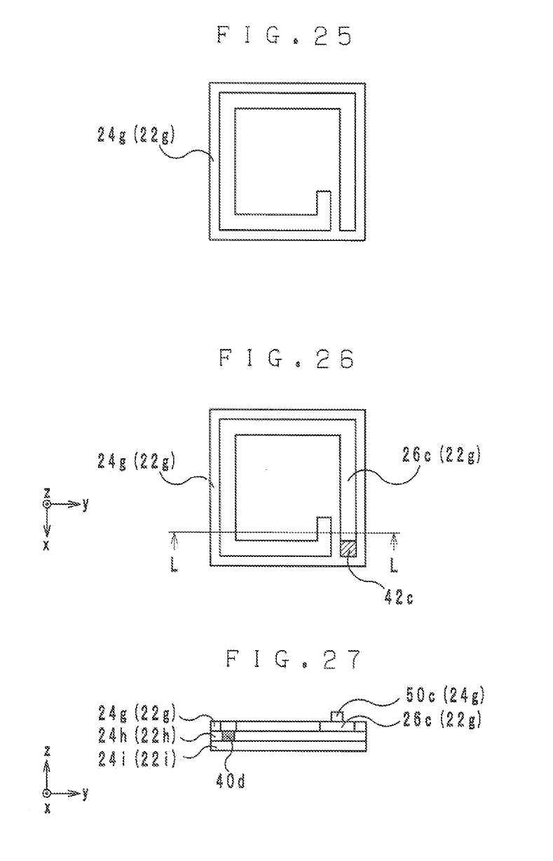

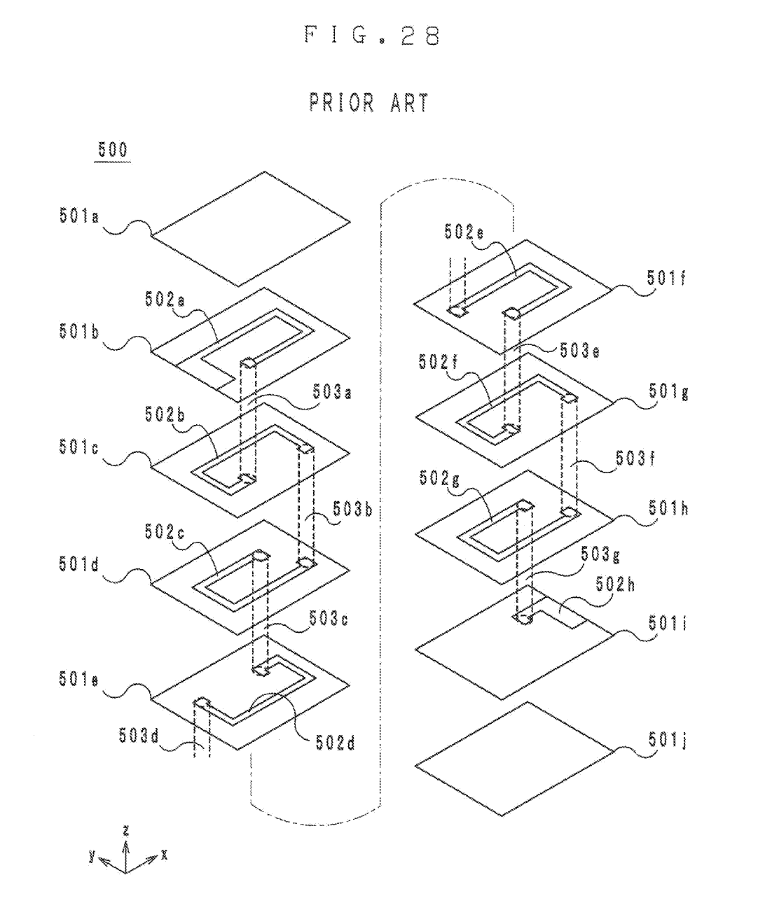

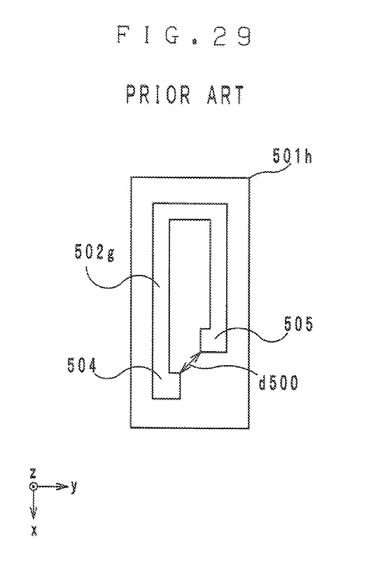

A manufacturing method of the multilayer coil 10 is described with reference to the drawings. Although FIGS. 9 to 24 show steps for producing one multilayer coil 10, actually, a mother laminate body that is an aggregation of multilayer coils 10 is produced at one time. FIGS. 9, 11, 13, 15, 17, 19, 21 and 23 are plan views of the multilayer coil 10 viewed from the z-axis direction, during the manufacturing process. FIG. 10 is a sectional view taken along the line D-D shown in FIG. 9. FIG. 12 is a sectional view taken along the line E-E shown in FIG. 11. FIG. 14 is a sectional view taken along the line F-F shown in FIG. 13. FIG. 16 is a sectional view taken along the line G-G shown in FIG. 15. FIG. 18 is a sectional view taken along the line H-H shown in FIG. 17. FIG. 20 is a sectional view taken along the line I-I shown in FIG. 19. FIG. 22 is a sectional view taken along the line J-J shown in FIG. 21. FIG. 24 is a sectional view taken along the line K-K shown in FIG. 23.

First, as shown by FIGS. 9 and 10, magnetic paste prepared by mixing ferrite powder, which is a magnetic material, with, for example, a binder is applied onto a substrate, for example, an aluminum substrate (not shown) by printing. The magnetic paste is dried, whereby the insulating layer 22i is formed.

Next, as shown by FIGS. 11 and 12, conductive paste mainly consisting of Ag, Pd, Cu, Ni or the like is applied onto the insulating layer 22i by printing, and the conductive paste is dried, whereby the coil conductor 40d is formed. Further, as shown by FIGS. 13 and 14, the magnetic paste is applied by printing onto the insulating layer 22i entirely except for the part on which the coil conductor 40d was formed. The magnetic paste is dried, whereby the magnetic layer 24h (insulating layer 22h) is formed.

Next, as shown by FIGS. 15 and 16, non-magnetic paste mainly composed of borosilicate glass and ceramic filler is applied by printing onto the insulating layer 22h and the coil conductor 40d so as to cover the coil conductor 40d. The non-magnetic paste is dried, whereby the non-magnetic part 26c is formed. Further, as shown by FIGS. 17 and 18, the magnetic paste is applied by printing onto the insulating layer 22h entirely except for the part on which the non-magnetic part 26c was formed. The magnetic paste is dried, whereby the magnetic part 24g is formed. In this way, the insulating layer 22g is formed. The insulating layer 22g is formed so as to have a via-hole for the via-hole conductor 42c. After the formation of the insulating layer 22g, the conductive paste is filled in the via-hole by printing, whereby the via-hole conductor 42c is formed.

Next, as shown by FIGS. 19 and 20, the non-magnetic paste is applied onto the non-magnetic part 26c by printing, and the non-magnetic paste is dried, whereby the insertion 50c is formed. At this stage, the non-magnetic paste is applied in such a position to be sandwiched between both ends (between the first part and the second part) of the coil conductor 40c that will be formed after the formation of the insertion 50c, when viewed from the z-axis direction.

Next, as shown by FIGS. 21 and 22, the conductive paste is applied onto the non-magnetic part 26c of the insulating layer 22g by printing. The conductive paste is dried, whereby the coil conductor 40c is formed. In this moment, both ends (the first part and the second part) of the coil conductor 40c are separated from each other by the insertion 50c. Thus, the conductive paste is applied for formation of the coil conductor 40c after the formation of the insertion 50c. Therefore, as shown by FIG. 8, the coil conductor 40c is formed so as to be located at the positive z-axis side of the insertion 50c along the boundary surface between the insertion 50c and the coil conductor 40c. Specifically, the side surfaces of the insertion 50c at the positive and the negative y-axis sides are curved so as to project further in the positive and the negative y-axis directions with increasing distance from the upper surface (the surface at the positive z-axis side) of the insertion 50c. Thereafter, the coil conductor 40c is formed to cover the side surfaces of the insertion 50c from the positive z-axis side.

Further, as shown by FIGS. 23 and 24, the magnetic paste is applied by printing onto the insulating layer 22g entirely except for the parts where the coil conductor 40c and the insertion 50c were formed. The magnetic paste is dried, whereby the magnetic layer 24f (insulating layer 22f) is formed.

Subsequently, the steps for forming the insulating layers 22g and 22f, the coil conductor 40c, the via-hole conductor 42c and the insertion 50c are repeated, whereby the insulating layers 22b to 22e, the coil conductors 40a and 40b, the via-hole conductors 42a and 42b, and the insertions 50a and 50b are formed. Thereafter, the magnetic paste is applied onto the insulating layer 22b by printing, whereby the magnetic layer 24a (insulating layer 22a) is formed. In this way, an unfired mother laminate body is formed.

Next, the unfired mother laminate body is cut into pieces of a specified size by a dicing saw, whereby a plurality of unfired laminate bodies 20 can be obtained.

The unfired laminate bodies 20 are subjected to debinding and firing. The debinding is carried out, for example, in a hypoxic atmosphere at 400 degrees C. for two hours. The firing is carried out at a temperature within a range from 870 degrees C. to 900 degrees C. for two hours and a half.

Through the steps above, fired laminated bodies 20 can be obtained. Each of the laminated bodies 20 is chamfered by barrel polishing. Thereafter, conductive paste of an Ag-based material is applied to each of the laminated bodies 20, and the applied conductive paste is baked at about 800 degrees C. for one hour. Thereby, silver electrodes for the external electrodes 30a and 30b are formed.

Finally, the silver electrodes are plated with Ni and/or Sn, whereby the external electrodes 30a and 30b are formed. Through the steps above, the multilayer coil 10 shown by FIG. 1 is completed.

### Advantageous Effects

The multilayer coil 10 and the manufacturing method thereof prevent a short circuit caused by blurring occurring at the time of printing coil conductors without reducing the number of turns of the coil. According to the manufacturing method of the multilayer coil 10, as shown by FIGS. 19 to 22, the insertion 50c is formed before the formation of the coil conductor 40c. Thereby, the closest parts to each other in the coil conductor 40c, that is, both ends of the coil conductor 40c are separated by the insertion 50c as shown by FIG. 8. Thus, the insertion 50c prevents both ends of the coil conductor 40c from contacting with each other due to blurring possibly occurring at the time of printing the coil conductor 40c. With regard to the coil conductors 40a and 40b, also, both ends of the respective coil conductors 40a and 40b are separated by the insertions 50a and 50b. Thereby, both ends of each of the coil conductors 40a and 40b are prevented from contacting with each other. Thus, the multilayer coil 10 and the manufacturing method thereof prevent a short circuit caused by blurring occurring at the time of printing coil conductors.

Since the coil conductor 40c is formed after the formation of the insertion 50c, as shown by FIG. 8, the coil conductor 40c is formed so as to be located at the positive z-axis side of the insertion 50c along the boundary surface between the insertion 50c and the coil conductor 40c. This prevents a short circuit from being caused by blurring occurring at the time of printing coil conductors.

In the multilayer coil 10, also, a reduction in inductance value due to magnetic saturation can be alleviated for the following reason. Generally, it is likely that magnetic saturation occurs in an area where coil conductors are located close to each other. Magnetic saturation is likely to occur also in an area where a material with a high-permeability material, that is, a magnetic material is disposed in a space between coil conductors. In the multilayer coil 10, a non-magnetic material is used for the insertions 50a to 50c that are disposed between the closest parts to each other in the coil conductor 40a, between the closest parts to each other in the coil conductor 40b and between the closest parts to each other in the coil conductor 40c, respectively. Thereby, magnetic saturation is prevented from occurring around the closest parts to each other in the coil conductor 40a, the closest parts to each other in the coil conductor 40b and the closest parts to each other in the coil conductor 40c, that is, around the ends of the coil conductor 40a, the ends of the coil conductor 40b and the ends of the coil conductor 40c, and accordingly, a reduction in inductance value can be alleviated.

### Modification

Next, an alternate multilayer coil according to a modification is described. FIG. 25 is a plan view from the positive z-axis side, showing a print pattern of a magnetic part 24g of the alternate multilayer coil. FIG. 26 shows a state where the magnetic part 24g has been printed to complete the insulating layer 22g. FIG. 27 is a sectional view taken along the line L-L shown in FIG. 26. The same elements and parts of the alternate multilayer coil as the multilayer coil 10 are provided with the same reference marks.

The alternate multilayer coil is different from the multilayer coil 10 in material of the insertions 50a to 50c. In the alternate multilayer coil, a magnetic material is used for the insertions 50a to 50c. This simplifies the manufacturing process of the alternate multilayer coil for the following reason.

As shown by FIG. 25, the print pattern of the magnetic part 24g for the alternate multilayer coil is partly changed from that for the multilayer coil 10 so that the printed magnetic part 24g can be formed to overlap with the non-magnetic part 26c. More specifically, as shown by FIG. 26, in a position corresponding to the position of the insertion 50c in the multilayer coil 10, the magnetic part 24g is printed on the non-magnetic part 26c in the alternate multilayer coil. Accordingly, the overlap portion of the magnetic part 24g and the non-magnetic part 26c, as shown by FIG. 27, protrudes in the positive z-axis direction from the upper surface of the other part of the magnetic part 24g. The protrusion made of the magnetic material serves as the insertion 50c. Therefore, it is not necessary to form the insertion 50c in a separate step after forming the magnetic layer 24g. The insulating layers 22c and 22e may be formed in the same way. Thus, the steps of forming the insertions 50 can be omitted from the manufacturing process of the alternate multilayer coil.

### Other Embodiments

Multilayer coils and manufacturing methods thereof according to the present disclosure are not limited to the multilayer coil 10 and the alternate multilayer coil and the manufacturing methods described above. Various changes and modifications may be possible within the scope. In the multilayer coil 10, the insertions 50a to 50c are located between the ends of the coil conductor 40a, between the ends of the coil conductor 40b, and between the ends of the coil conductor 40c, respectively. However, the insertions 50a to 50c may be located in any other positions between the close parts to each other in the coil conductor 40a, between the close parts to each other in the coil conductor 40b and between the close parts to each other in the coil conductor 40c, respectively. In each of the coil conductors 40a to 40c, the closest parts to each other may be other than its both ends. In this case, each of the insertions 50a to 50c shall be located between the closest parts in each of the conductors other than its both ends.

What is claimed is:

1. A multilayer coil comprising:
a laminate body formed by stacking a plurality of insulating layers including a specified insulating layer;
a linear coil conductor substantially looped on the specified insulating layer; and
an insertion located on the specified insulating layer, in a position between a first part and a second part of the coil conductor, the first part and the second part being closest parts to each other in the coil conductor,
wherein along a boundary surface between the first part of the coil conductor and the insertion, the first part is located at an upper side of the coil conductor with respect to a stacking direction.

2. The multilayer coil according to claim 1, wherein the plurality of insulating layers and the insertion are made of a same material.

3. The multilayer coil according to claim 1, wherein:
parts of the specified insulating layer contacting with one of the coil conductor and the insertion are non-magnetic; and
a remaining part of the specified insulating layer is magnetic.

4. The multilayer coil according to claim 1, wherein the insertion is non-magnetic.

5. A method for manufacturing a multilayer coil having a laminate body formed by stacking a plurality of insulating layers including a specified insulating layer, a linear coil conductor substantially looped on the specified insulating layer, and an insertion located on the specified insulating layer, in a position between a first part and a second part of the coil conductor, the first part and the second part being closest parts to each other in the coil conductor, the method comprising:
forming the specified insulating layer;
forming the insertion on the specified insulating layer; and
forming the coil conductor on the specified insulating layer after the step of forming the insertion.

6. The method for manufacturing a multilayer coil according to claim 5, wherein the plurality of insulating layers and the insertion are made of a same material.

7. The method for manufacturing a multilayer coil according to claim 5, wherein the step of forming the specified insulating layer includes:
forming a part of the insulating layer as a non-magnetic part, the part being in a position to come into contact with the coil conductor and the insertion; and
forming the remaining part of the insulating layer as a magnetic part.

8. The method for manufacturing a multilayer coil according to claim 5, wherein the insertion is non-magnetic.
